(19) United States
(12) Patent Application Publication
(10) Pub. No.: US 2017/0122039 A1
(43) Pub. Date: May 4, 2017

(54) COMPOSITE SUCKER ROD ASSEMBLY MADE BY RESIN INFUSION

(71) Applicant: Lifting Solutions Inc., Edmonton, CA (US)

(72) Inventor: Robbie Sjostedt, Foothill Ranch, CA (US)

(21) Appl. No.: 15/338,143

(22) Filed: Oct. 28, 2016

Related U.S. Application Data
(60) Provisional application No. 62/248,098, filed on Oct. 29, 2015.

(51) Int. Cl. E21B 17/00; B29C 70/44; B29C 70/46

(52) U.S. Cl. CPC E21B 17/00; B29C 70/462; B29C 70/443; B29K 2063/00

(57) ABSTRACT

A composite sucker rod assembly is provided for use in down-hole wells. The sucker rod assembly includes a plurality of wound fiber strength elements that are drawn into an in-situ mold tube or clamshell and resin-infused in conjunction with creating a conical wedge terminus connection for at least one end-fitting. Each terminus fitting has a tapered cavity with a proximal opening to receive the composite material. The cavity is tapered so as to flare outwardly from said cavity's proximal opening toward the cavity's distal end. A two-piece cruciform or single piece pin insert interlocks with the wound fiber elements and the terminus fitting to form a high strength connection. The assembly is tensioned prior to infusing and curing the resin matrix for the composite. The mid-span of the sucker rod or tension member can be molded in an oval, elliptical or airfoil shape by various means.

### CROSS-REFERENCE TO RELATED APPLICATIONS

This application claims priority of U.S. provisional patent application Ser. No. 62/248,098 filed Oct. 29, 2015, which is incorporated by reference into this application in its entirety.

### TECHNICAL FIELD

The present disclosure is related to the field of sucker rod engineering, design and method of manufacture, in particular, to composite sucker rod assemblies for use in down-hole vertical lift oil extraction.

### BACKGROUND

Sucker rods for use with vertical lift rod pumps, actuated by surface units, also referred to as rocking horse or pump jacks, are traditionally made from individual lengths of steel rod sections connected together by threaded couplings. Individual sucker rods are typically 25 feet, 30 feet or 37.5 feet in length and are connected together with screw together couplings to form a sucker rod string. A typical sucker rod string is from 700 to 10,000 feet or more in length. The sucker rod string connects the vertical lift surface device to the down-hole pump unit. Traditional metal sucker rods are heavy and subject to corrosion and fatigue failure, particularly at the threaded connections or due to stress corrosion cracking. An unexpected broken sucker rod due to corrosion and/or fatigue is expensive to remove and replace. Furthermore, the weight of a metal sucker rod string limits its strength and fatigue life and can limit the depth which even large surface units can pump since the string is hanging on itself. The weight of a steel sucker rod string can also overload and reduce the life of the surface unit and its components. Monolithic fiberglass sucker rods have also been in use for some time. Fiberglass sucker rods do offer a weight reduction and corrosion resistance but have significant stretch and are prone to splitting and failing due to transient compression forces in the rod string.

Current sucker rod technology primarily consists of wrought steel rods that are typically ¾ inch diameter, ⅞ inch diameter, 1 inch diameter, or 1¼ inch diameter. The ends of the rods are formed to include a wrench location and threaded to interface with couplings that join the individual rods together. The typical steel sucker rod lengths are 25 feet and 30 feet. A string of segmented sucker rods is connected to the pumping unit at the surface and the down-hole pump at or near the bottom of the oil well. While the surface unit is operating more or less vertically, the well bore may be at an angle or even turned off horizontal as a result of directional drilling techniques. Shorter rods often called “Pony Rods” are used to fine tune the overall length of the sucker rod string and the position of the pump down-hole. Sinker Bars (larger diameter heavy rods) are used at the bottom of the well to weight the entire string for the down-hole stroke. The sucker rods reciprocate up and down in a tube that is typically steel and suspended in the well bore or casing. No well is perfectly straight. Steel sucker rods are stiff and often cause excessive wear on the inside of the well tubing where the well is not straight. In addition, the flex in the string induced by pumping causes metal fatigue particularly at the threaded joints that can cause the sucker rod to break. The highly corrosive environment worsens the frequency of rod failures.

Monolithic fiberglass sucker rods have been developed. The fiberglass rods have steel end fittings bonded over the outside surface of each end of the monolithic fiberglass rod. Fiberglass sucker rods are typically larger in diameter compared to their steel counterparts. Fiberglass sucker rods have a lower tensile modulus than steel or carbon fiber and therefore exhibit more stretch than steel or carbon fiber. This stretch typically results in less pump stroke at the bottom of the string than the top of the string. Fiberglass sucker rods are lighter weight than steel but have been known to suffer premature failure if subjected to any compression loading during the pumping cycle. Fiberglass sucker rods have been traditionally made by the pultrusion process wherein fiber and resin is drawn through a heated die to form the rod shape and cure the matrix resin.

A carbon fiber composite sucker rod pultruded as a monolithic round bar like a fiberglass rod would not be attractive because it would be subject to compression failure similar to fiberglass and it would be difficult to make the terminus end fitting match the strength potential of the carbon fiber composite mid-section since it would be merely glued on the outside of the monolithic rod or split and a wedge insert installed (like a hammer handle) versus tying into the majority of the fibers that make up the strength of the monolithic rod.

It is, therefore, desirable to provide a sucker rod assembly that can meet or exceed all operational requirements and offer significant weight reduction, complete corrosion resistance, deeper pumping capability, less maintenance and service life advantages over previous sucker rods.

### SUMMARY

A composite sucker rod assembly is provided that can address the aforementioned disadvantages by providing an improved sucker rod assembly for use in down-hole vertical lift oil extraction.

In some embodiments, the sucker rod assembly does not utilize the pultrusion process to form a rod member for the mid-span of the composite sucker rod. In some embodiments, the sucker rod assembly can use a resin infusion process to form not only the mid-span composite rod but to create the terminus mechanical connection to the end-fittings in a single process step.

Dry carbon fiber tows, fiberglass roving or other high strength fiber strands can be wound in a continuous loop nearly the length of the completed sucker rod assembly. The fiber bundle can be drawn into a tubular mold such as a polyethylene (“PE”) tube or a clamshell mold that is slightly shorter in length. The cross section of the total bundle of fibers can be approximately 70% of the inside cross sectional area of the PE tube to allow for resin to be infused or pressured or both into the tubing to make a composite laminate at the desired fiber/resin ratio. End-fittings can be slid onto the PE tube prior to drawing the fiber through the PE tube. The fiber bundle that hangs out each end of the PE tube can be looped over a cruciform insert and the end-fittings are pulled outwards to their proper position. The cruciform insert can fit into a hollow conical cavity in the end-fittings. In some embodiments, the fiber bundle can be looped over a round metal pin in lieu of the cruciform insert. The round metal pin can fit cross-wise in the hollow conical cavity in the end-fitting at the large end. The dry preform can be placed in a fixture to hold it straight and locate the end fittings. The fiber bundle loop can be carefully sized in length such that when the end-fittings are pulled outward to their proper location, the fibers are straight and slightly tensioned. Epoxy, or alternatively vinyl ester, phenolic, cyanurate ester, or benzoxyzene resin can be pressure-infused through ports in the end fittings and through the PE tube to impregnate the fibers and make a composite. When the resin is cured, the resultant part is then a usable sucker rod. The PE tube can be cut off with a utility knife or left on as a wear resistant covering. In some embodiments, the resin can be infused or pressured or both into the end-fittings and then resin can be infused or pressured or both into the tubular mold at incremental points along the length of the tube.

It is also noteworthy that a lighter weight carbon fiber sucker rod contributes to less stress on the threaded pin and coupling components for sucker rods thereby reducing the frequency of pin failures.

Broadly stated, in some embodiments, a carbon fiber rod assembly can be provided, the assembly comprising: a retention insert; a plurality of carbon fiber filaments wound around the retention insert and drawn into a length away from the retention insert; a terminus fitting comprising a proximal end and a distal end defining a cavity therebetween, the terminus fitting flaring outwardly from the proximal end to the distal end, wherein the plurality of carbon fiber filaments are drawn through the cavity in the terminus fitting from the distal end to the proximal end until the retention insert is disposed in the cavity; and resin disposed into the cavity, wherein the resin is infused in the plurality of carbon fiber filaments and constrains the plurality of carbon fiber filaments to the retention insert and to the terminus fitting when the resin hardens.

Broadly stated, in some embodiments, a carbon fiber rod assembly can be provided, the assembly comprising: a plurality of loops of carbon fiber filaments stretched between a first end and a second end; a retention insert disposed at each of the first and second ends; a terminus fitting comprising a proximal end and a distal end defining a cavity therebetween, the terminus fitting flaring outwardly from the proximal end to the distal end, wherein the plurality of carbon fiber filaments are drawn through the cavity in the terminus fitting from the distal end to the proximal end until the retention insert is disposed in the cavity; and resin disposed into the cavity, wherein the resin is infused in the plurality of loops of carbon fiber filaments and constrains the plurality of loops of carbon fiber filaments to the retention insert and to the terminus fitting when the resin hardens.

Broadly stated, in some embodiments, the retention insert can comprise a cruciform insert, further comprising a plurality of branches extending away form a cruciform joint, the plurality of branches spaced substantially equally apart, the plurality of carbon fiber filaments wound around at least one of the plurality of branches

Broadly stated, in some embodiments, each of the plurality of branches can comprise a trapezoidal configuration.

Broadly stated, in some embodiments, the retention insert can comprise a rod insert.

Broadly stated, in some embodiments, the plurality of carbon fiber filaments can be under tension.

Broadly stated, in some embodiments, the resin can be infused in the plurality of carbon fiber filaments along the length away from the terminus fitting.

Broadly stated, in some embodiments, a tubular mold can be disposed around the plurality of carbon fiber filaments.

Broadly stated, in some embodiments, resin can be infused and/or pressured in the plurality of carbon fiber filaments within the plastic tube.

Broadly stated, in some embodiments, a fiber sleeve can enclose the plurality of carbon fiber filaments within the plastic tube.

Broadly stated a flow media material may be included around the outside of the fiber package or alternatively within the fiber package.

Broadly stated, in some embodiments, the ratio of the plurality of carbon fiber filaments to resin by volume can be in the range of approximately 60/40 to 75/25.

Broadly stated, in some embodiments, a method can be provided for assembling a carbon rod assembly, the method comprising the steps of: stretching a plurality of loops of carbon fiber filaments between a first end and a second end; placing a terminus fitting comprising a proximal end and a distal end defining a cavity therebetween, wherein the terminus fitting flares outwardly from the proximal end to the distal end, wherein the plurality of loops of carbon fiber filaments are drawn through the cavity in the terminus fitting; placing a retention insert at each of the first and second ends; wrapping the plurality of loops of carbon fiber filaments around the retention insert; drawing the plurality of loops of carbon fiber filaments through the cavity in the terminus fitting from the distal end to the proximal end until the cruciform insert is disposed in the cavity; and placing resin in the cavity, wherein the resin infuses in the plurality of loops of carbon fiber filaments and constrains the plurality of loops of carbon fiber filaments to the retention insert and to the terminus fitting when the resin hardens.

Broadly stated, in some embodiments, the method can further comprise the step of placing a tubular mold around the plurality of loops of carbon fiber filaments.

Broadly stated, in some embodiments, the method can further comprise the step of infusing the resin in the plurality of loops of carbon fiber filaments within the tubular mold.

Broadly stated, in some embodiments, the method can further comprise the step of incorporating a flow media material within or around the plurality of carbon fiber filaments before placing the tubular mold around the plurality of loops of carbon fiber filaments

Broadly stated, in some embodiments, the method can further comprise the step of placing a fiber sleeve around the plurality of carbon fiber filaments before placing the plastic tube around the plurality of loops of carbon fiber filaments.

Broadly stated, in some embodiments, the method can further comprise the step of manipulating the plastic tube to form a non-circular cross-sectional shape as the resin hardens.

Broadly stated, in some embodiments, the tubular mold can comprise a clamshell mold.

Broadly stated, in some embodiments, the method can further comprise the step of heating the clamshell mold to more rapidly cure the resin.

Broadly stated, in some embodiments, the tubular mold can comprise a plastic tube.

Broadly stated, in some embodiments, the method can further comprise the step of removing the plastic tube from the carbon rod assembly after the resin has hardened.

Broadly stated, in another embodiment wherein a metal pin is used in lieu of the cruciform, the fiber is wound in only one bundle and the pin at each end is positioned such that the pin restrains the loops of fibers so they can be tensioned in the same manner as described for the cruciform.

### BRIEF DESCRIPTION OF THE DRAWINGS

FIG. 1A is a side elevation view depicting pieces of a cruciform insert for a composite sucker rod assembly.

FIG. 1B is a perspective view depicting the cruciform insert pieces of FIG. 1 as an interlocked assembly.

FIG. 2 is a side exploded view depicting the cruciform insert assembly of FIG. 1B halfway out of an end-fitting cone, and with fibers wrapped over the four edges of the cruciform insert assembly.

FIG. 3 is a cross-section view depicting fibers within a PE tube.

FIG. 4 is a side elevation view depicting a general arrangement of a sucker rod assembly.

FIG. 5 is a perspective view depicting 76 dry carbon fiber tows wrapped around two pins that are 30 feet apart.

FIG. 6 is a perspective view depicting a braided fiberglass sleeve bunched up on a bayonet mandrel in preparation for being stretched over the carbon fiber tows of FIG. 5.

FIG. 7 is a perspective view depicting the fiberglass sleeve of FIG. 6 slid onto the carbon fiber tows of FIG. 5.

FIG. 8 is a perspective view depicting four carbon fiber bundles being pulled into position to receive a cruciform of FIG. 1B.

FIG. 9 is a cross sectional view depicting the end-fitting cone with the carbon fiber bundles wound around a rod insert.

### DETAILED DESCRIPTION OF EMBODIMENTS

A composite sucker rod assembly 400 made by resin infusion is provided. In some embodiments, a typical carbon fiber tow (where “tow” is defined as a single strand of filaments) suitable for a carbon fiber sucker rod 400 can have 24,000 (“24K”) filaments per tow, although other tow sizes can also be used. The individual filaments that make up carbon fibre tow 310 can be approximately 6-7 microns diameter. Hence, there is a definable cross sectional area for a 24K carbon fiber tow. A 24K carbon fiber tow can be wound multiple times around two metal pins 510 spaced just under 30 feet apart. Carbon fiber tow 310 can be hand wound around pins 510, or machined wrapped with what is typically called a fiber pin winder. This can be the first step in a method for preparing the fiber to make resin-infused carbon composite sucker rod 400.

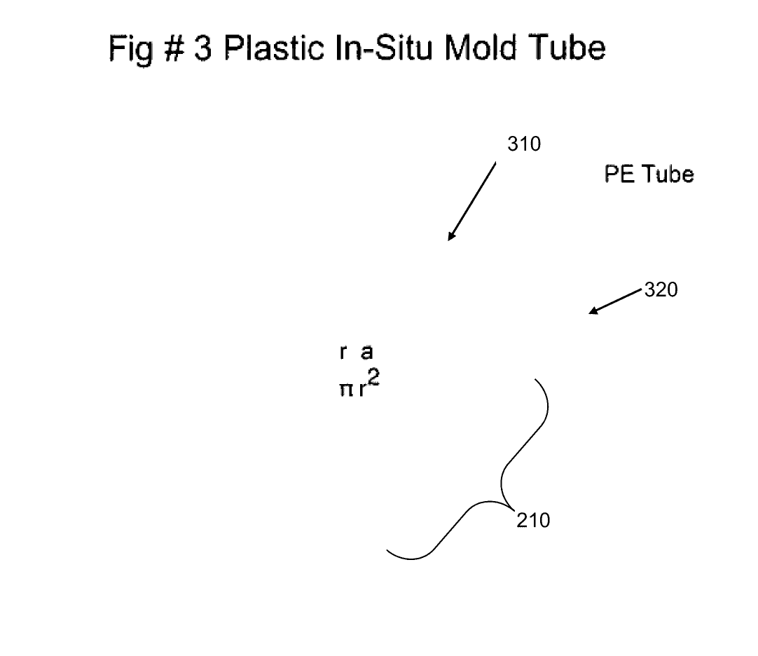

In some embodiments, a tubular mold, such as a tube made of polyethylene (“PE”) 410 or a clamshell mold, not shown, can be sized to be approximately 29 feet in length by way of example for a 30 foot sucker rod. A longer tubular mold is required for longer sucker rod lengths. Metal end-fittings 230 can be slid over PE tub 410 at each end. A string can be passed through PE tube 410 and tied to one loop end 220 of the dry carbon fiber tow bundle 210, as described above. By pulling on the string and holding PE tube 410, the dry carbon fiber tow bundle 210 can be drawn into and through PE tube 410. The inside cross section area of PE tube 410 can be sized to be roughly 30% larger than the combined cross sectional area of the entire carbon fiber tow bundle 210. In some embodiments, the relationship of composite fiber to resin volume can be approximately 70% fiber and approximately 30% resin when resin is pressured into the tube and cured in place. This relationship can also allow the carbon fiber bundle to be drawn into the PE tube 410, as shown in FIG. 3. While a 70/30 fiber to resin volume ratio can be a representative embodiment for a sucker rod assembly application, the fiber to resin volume ratio can be in the range of approximately 60/40 to 75/25, and can be adjusted further up or down to suit specific performance requirements.

In some embodiments, a flow media material can be incorporated within or around carbon fiber tow bundle 210 to facilitate infusion or pressure feeding the resin into PE tube 410.

A clam-shell mold may be used in lieu of PE tube 410 to define the outside shape of sucker rod body 400.

Once the wound carbon fiber tow bundle 210 is drawn into PE tube 410, carbon fiber tow bundle 210 can be centered such that carbon fiber loop ends 220 are hanging outside the PE tube 410 equally. It is noteworthy that other materials can also be used for the tubular mold depending on the application.

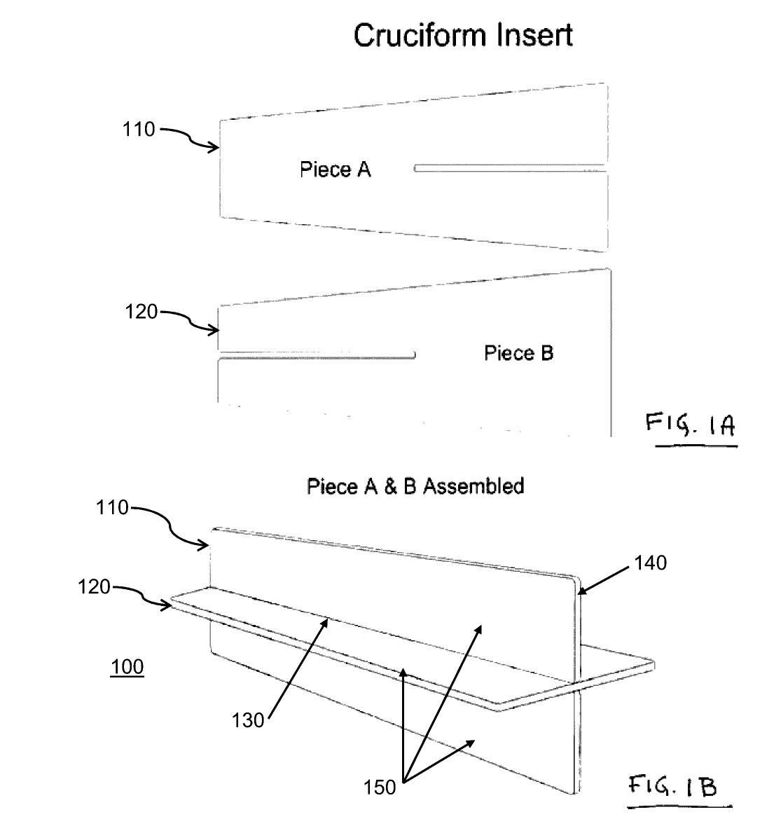

In some embodiments, cruciform insert 100 can be made by shaping two pieces 110, 120 from flat fiberglass laminate sheet (typically called G-10) or other suitable material as well known to those skilled in the art. Two pieces 110, 120 can be roughly trapezoidal in shape such that they fit inside conical cavity 240 in metal end-fitting 230, as shown in FIG. 1A. Two trapezoidal shaped pieces 110, 120 can be notched so they interlock together to make tapered cruciform shaped insert 100 with four sides or branches 150 extending away from cruciform joint 130, the branches spaced substantially equally apart in an orthogonal arrangement, as shown in FIG. 1B. In some embodiments, the edges of cruciform insert pieces 110, 120, in particular the larger back edge 140 of cruciform 100, can have a radius. In some embodiments, cruciform 100 can be stamped out of metal, or it can be injection molded or it can be made by rapid prototyping technology.

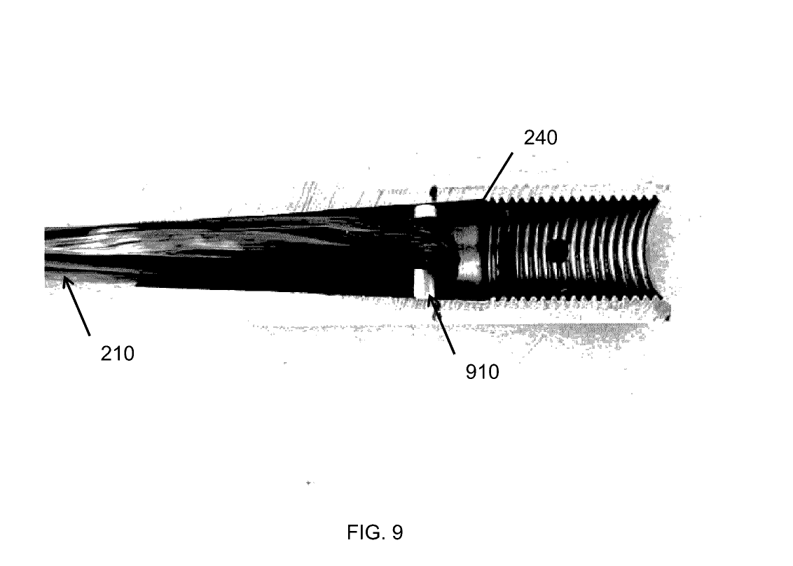

In some embodiments, in lieu of cruciform 100, round metal pin 910 can be shaped to fit cross-wise in hollow conical end-fitting 230 as shown in FIG. 9. Carbon fiber tow bundles 210 are wrapped around the pin 910 at each end of sucker rod 400. Pin 910 is wedged into cavity 240 when the carbon fiber tow bundles 210 are tensioned.

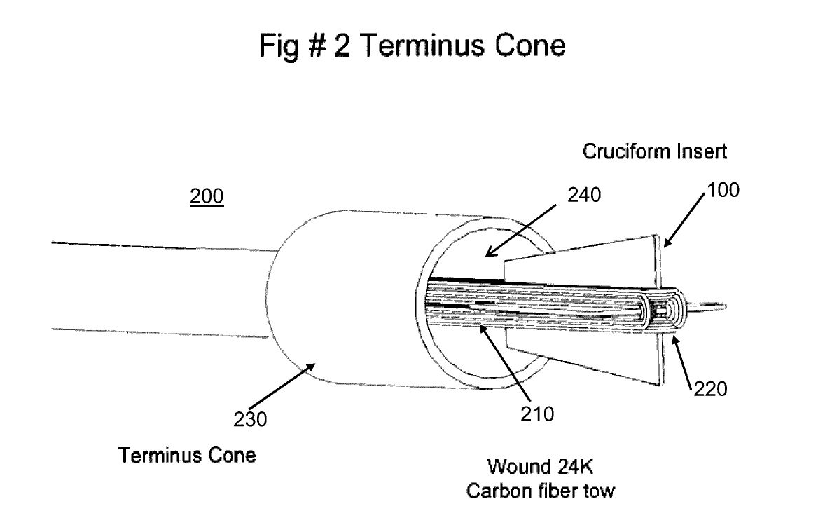

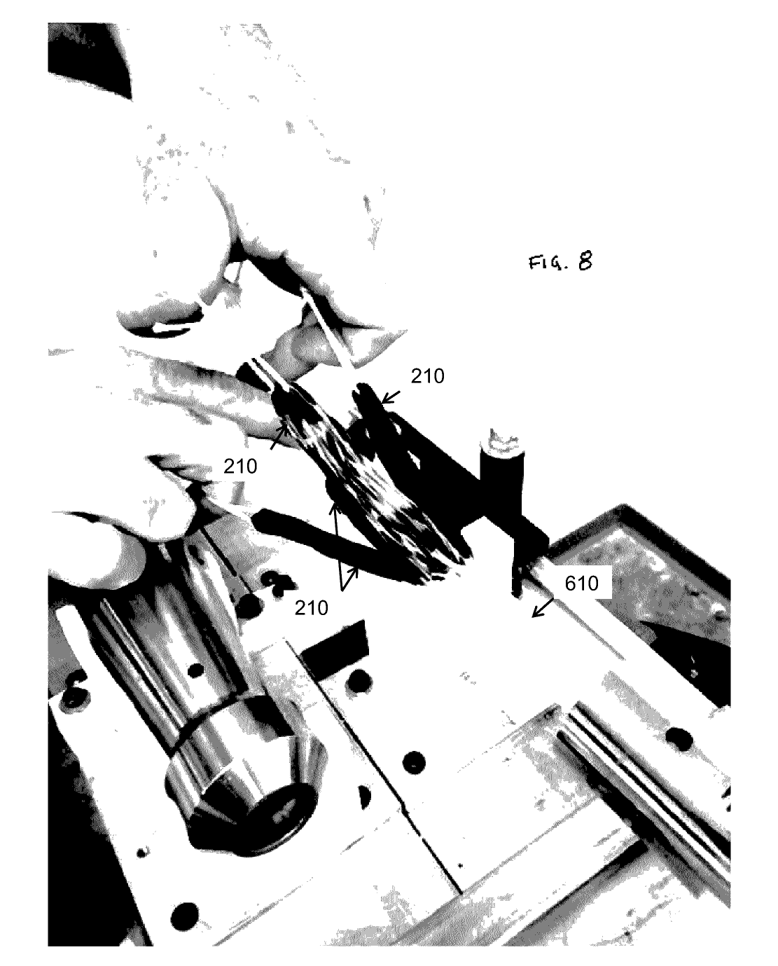

In some embodiments, the dry carbon fiber tow bundle 210 sticking out of PE tube 410 can be divided into four equal bundles 210. FIG. 8 shows four such bundles of carbon fiber tows 210 being pulled into position prior to installing cruciform 100, such as shown in FIG. 1B. Each of the four branches 150 of cruciform insert 100 can be inserted in one of the four dry fiber loop ends 220, as shown in FIG. 2. When metal end-fitting 230 is slid outwards, it can engage with cruciform insert 100 and carbon fiber tow bundle 210 can be drawn into end-fitting 230 along with cruciform insert 100. This can be done on both ends and when tension is applied to both end-fittings 230, it can tension dry fibers 310 within the tube equally. The length of the wound dry carbon fiber tow bundle 210 can determine the final length of carbon fiber sucker rod 400.

In embodiments, when single metal pin 910 is used in lieu of cruciform 100, the dry carbon fiber tow bundle 210 can be a single loop rather than four loops packaged together to fit around cruciform insert 100.

Carbon fiber composite sucker rod assembly 400 (sans resin) described above can then be loaded onto an assembly fixture that can locate end fittings 230 and maintain tension on end fittings 230 and, thus, ensure that PE tube 410 is straight.

In some embodiments, epoxy resin can be pressured into a port in each end-fitting 230 using a conventional paint pot pressurized with compressed air or other means. A vacuum can be pulled in the center of the sucker rod, if desired, by tapping into PE tube 410 to assist resin infusion and prevent trapped air in the tube. Vacuum bag adhesive putty can be used to seal PE tube 410 to end-fitting 230 while the resin is being pressured into the carbon fiber laminate. In some embodiments, the resin can comprise epoxy. In other embodiments, vinyl ester, phenolic, cyanurate ester and benzoxyzene resins can also be suitable, each having unique properties for various applications, as well known to those skilled in the art. For longer lengths of sucker rods greater than the current lengths 25, 30 or 37.5 feet, multiple resin infusion ports and multiple vacuum ports can be incorporated in order to infuse the resin. In some embodiments, the resin may be infused by pulling a vacuum on PE tube 410 or by a combination of vacuum and pressure.

In some embodiments, the resin can be infused or pressured or both into end-fittings 230 and then resin can be infused or pressured or both into PE tube 410 or a clam shell mold at incremental points along length of the PE tube 410 or clamshell mold.

The infused resin can be allowed to cure at room temperature or can be accelerated using a drop down oven enclosure over sucker rod 410. In some embodiments, the resin in cone wedge cavity area 240 of each end-fitting 230 can be post cured at elevated temperature for maximum heat resistance down-hole. This can be accomplished by heating end-fitting 230 to 300 F. In some embodiments, an RF induction heat source can be used as an example heating source.

After the infused resin is cured, PE tube 410 can be removed, if desired, using a utility knife with a depth control shoe. PE tube 410 can also be left in-place to provide an added layer of protection and wear resistance to the carbon fiber composite. Other materials suitable for the plastic tube can be polyether imide (“PEI”) plastic, polyphenylene (“PPS”) plastic and polyether ether keytone (“PEEK”) plastic, plus any combinations thereof as well known to those skilled in the art.

A clamshell mold the length of sucker rod 400 can be utilized in lieu of PE tube 410. The clamshell mold can be heated to more rapidly cure the resin that is infused or pressured or both into the mold.

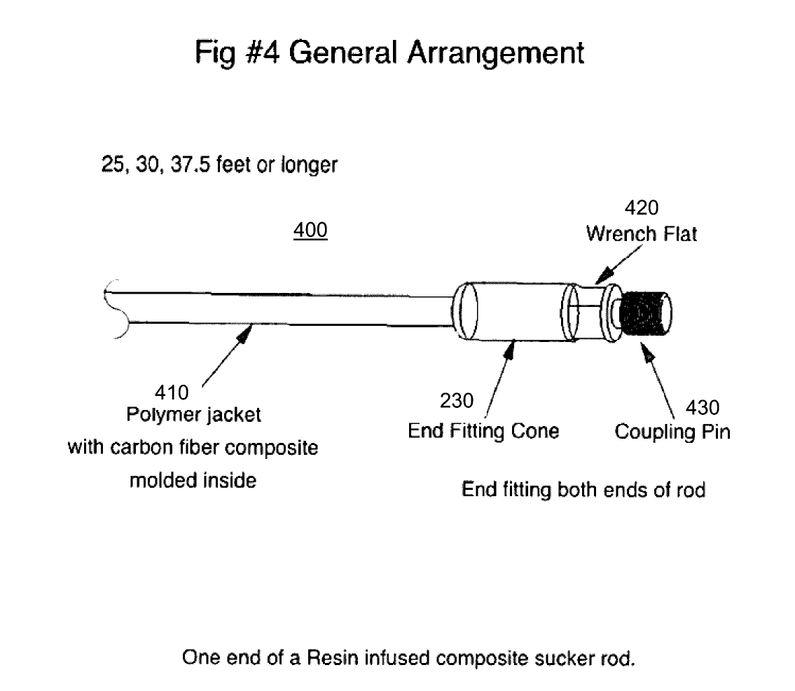

Referring to FIG. 4, one embodiment of a general arrangement of resin-infused composite sucker rod assembly 400 is shown. In this embodiment, assembly 400 can comprise resin-infused carbon fiber tow bundles 210 encased in a polymer or plastic jacket (PE tube 410) with end fitting cone 230 disposed at either or both ends of rod assembly 400. End fitting cones 230 can further comprise one or more wrench flats 420 for receiving a wrench for turning end fitting cone 230. End fitting cones 230 can also comprise coupling pin 430 extending therefrom for coupling to another rod assembly.

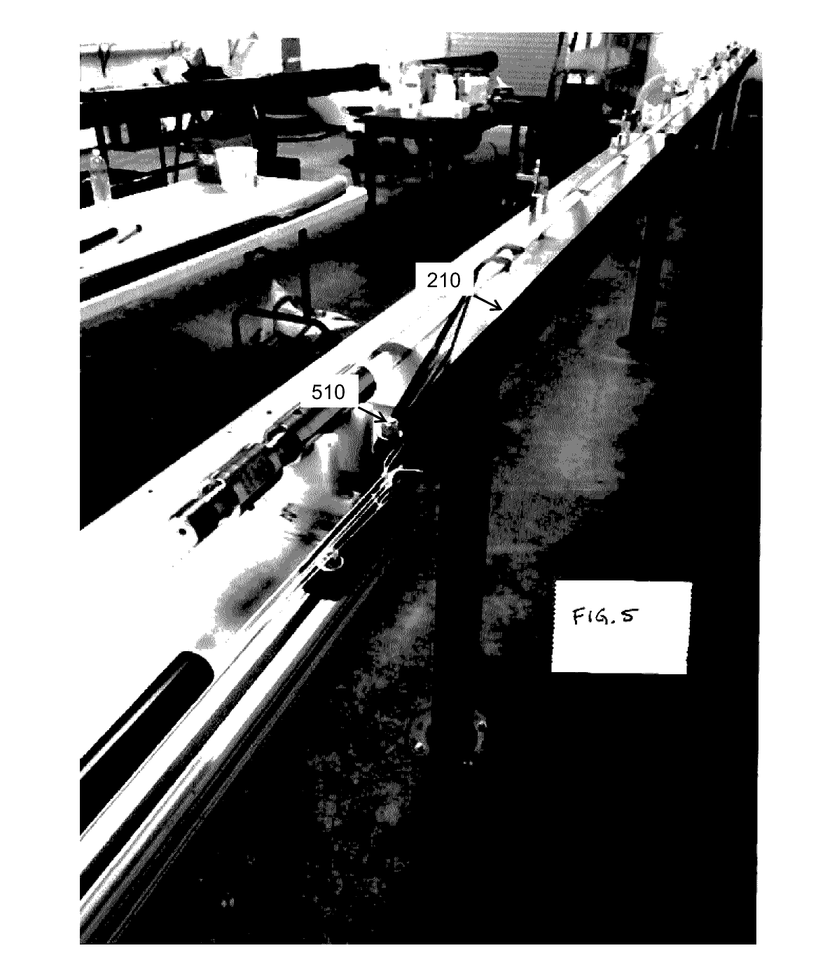

Referring to FIG. 5, 76 carbon fiber tow bundles 210 (each tow having 24,000 carbon fiber filaments) are shown wrapped two pins 510 spaced 30 feet apart. This example can produce a ½″ diameter rod having 70% fiber volume and further having a 0.010″ thick braided fiberglass sleeve 610 placed over carbon fiber tow bundles 210.

While the assembly and method described herein are primarily directed towards a design and method of manufacture for composite sucker rods, it is noteworthy that it can also be used to make tension members for other applications such as curtain wall stiffeners, building tension trusses, bridge tension members, sailboat rigging amongst other things.

Another noteworthy feature is the ability to use a shaped PE tube or clamshell mold as an in situ mold to shape the composite member when it is resin-infused. For example, the tube or mold can be deflected to be elliptical shaped in cross section in the mid span prior to resin infusion. If PE tube 410 is clamped in an elliptical shape, then the resultant composite cured within will also be an elliptical shape. This feature can be an important for high performance racing sailboat rigging to reduce wind drag. An elliptical or airfoil shaped tension member may have utility for other applications. Pre-shaped PE tubes or molds can also be used to control the shape of the resin-infused carbon fiber filaments molded within. In some embodiments, a clam-shell style mold can be used in place of PE tube 410 to shape the resin-infused carbon fiber filaments until the resin hardens. In other embodiments, vacuum-bagging techniques can be used to mold the resin-infused carbon fiber filaments.

In some embodiments, off-axis fibers can be added to the composite sucker rod mid-span to improve the bending strength and compressive strength of the sucker rod. This can be accomplished by first drawing the dry carbon fiber tow bundle 210 through a braided fiberglass, carbon fiber or aramid tubular sleeve 610. The combined carbon fiber tow bundle 210 and braided sleeve 610 can then be drawn into the PE tube 410 and resin-infused. The braided sleeve 610 can then become an integral part of the composite when the infused resin is cured. The cross-sectional area of braided sleeve 610 must be accounted for in sizing PE tube 410 so that the ideal fiber/resin ratio for the resin-infused composite can be maintained.

Tubular braided composite dry fiber forms are readily available in fiberglass, aramid fiber, carbon fiber and PVC fiber. In some embodiments, these materials can be integrated into the sucker rod laminate structure if desired. They can provide a wear resistant protective covering over the unidirectional carbon fibers, and they can further provide off-axis strength to the sucker rod that can prevent the potential of splitting of the carbon fiber tows, and can further enhance the compressive strength of the sucker rod.

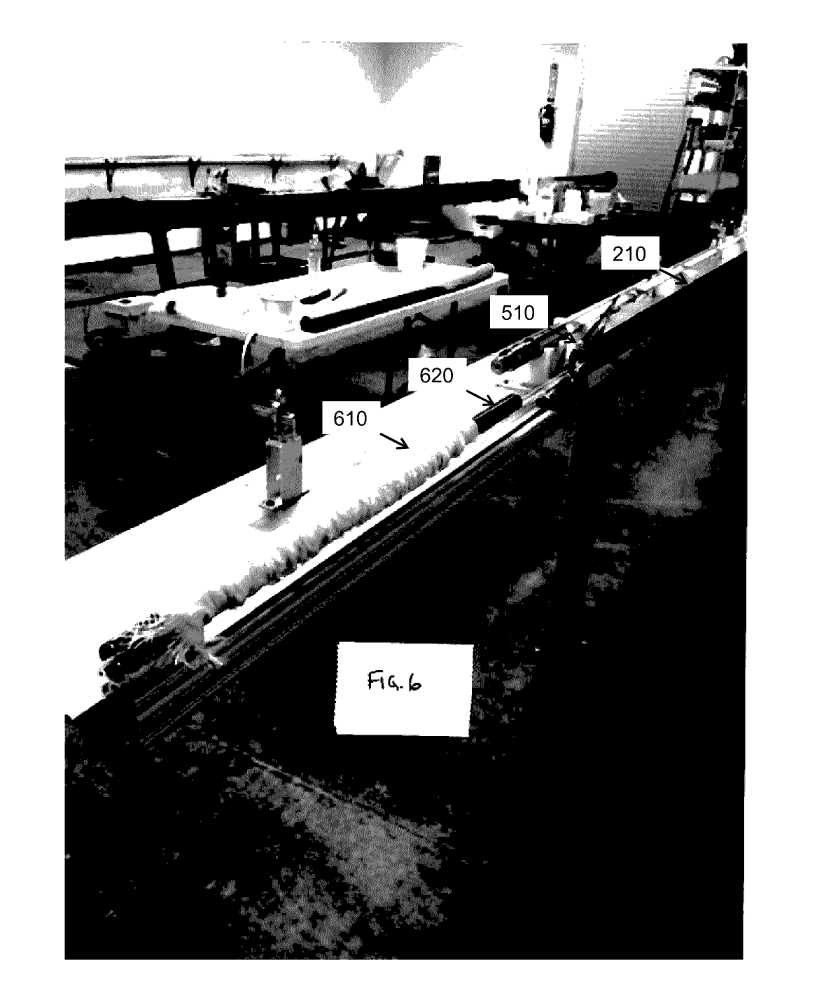

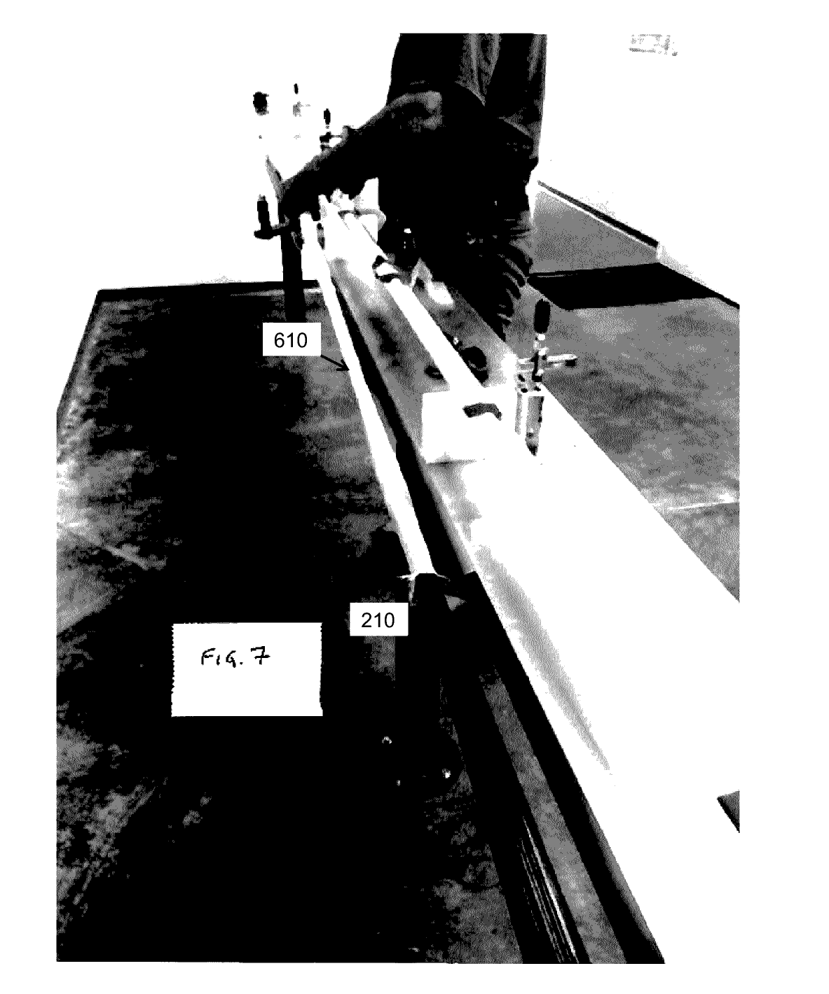

In some embodiments, tubular braided fiber sleeve 610 can be built into sucker rod structure 400 by first pulling carbon fiber tow bundle 210 through braided sleeve 610. As shown in FIG. 6, braided sleeve 610 can be “bunched up” to be shorter and a larger diameter to make it easy to pull carbon fiber tow bundle 210 through braided sleeve 610. FIG. 6 shows one embodiment of tubular fiberglass sleeve 610 bunched up on bayonet mandrel 620 before being pulled over carbon fiber tow bundle 210. Braided sleeve 610 can then be stretched back to its original configuration by “smoothing” it down with one's hand over the outside. The braided dry fiber form can be lashed at one end to facilitate drawing the entire fiber package into the plastic tube. FIG. 7 shows fiberglass sleeve 610 of FIG. 6 being pulled over carbon fiber tow bundle 210.

Carbon fiber tow bundle 210 with its outer layer braided sleeve 610 can now be pulled into plastic tube 410 for resin infusion. When the resin is infused into plastic tube 410, it can “wet-out” both carbon fiber tow bundle 210 and braided sleeve 610 to become one homogeneous composite structure. When the resin cures, it can create a composite structure with both axial unidirectional fibers at the core and braided off-axis fibers over the outside of the rod. The addition of off-axis fibers substantially can increase the resultant sucker rod's ability to handle compressive loads without splitting.

In some embodiments, the PE (or other polymer) tube 410 can be clamped along its length such that it is oval in cross section shape prior to infusing and curing the resin for the composite sucker rod. This can create a monolithic oval cross section for the rod which can be coiled to a smaller diameter than a round cross section.

After drawing the carbon fiber bundle 210 through the plastic tube 410, end fitting metal cones 230 can be slid over the bundle. Cruciform 100 or metal rod 910 can then be installed in one end looping the carbon fiber tow bundle 210 over the back edges 140 of the cruciform 100 in four places. The end fitting cone 230 can then be slid back over the cruciform 100 or metal rod 910. A connection pin can be threaded into the cone, and the end fitting anchored to the assembly fixture, to hold it straight and in position for resin infusion. The same process can then be done for the second end of the sucker rod. In some embodiments, some tension can be applied to the second end such that it can pull the fiber bundle tight axially and equalize the tension on all carbon fiber tow elements of the carbon fiber tow bundle 210 prior to infusing resin into the plastic tube.

In some embodiments, four individual carbon fiber bundles 210 can be pinned rather than one. Four strings can be tied to the four individual carbon fiber bundles 210 or “hanks” of fiber, and all four hanks 210 can be drawn into the PE tube 410 with or without braided sleeve 610 over the outside. In this embodiment, the drawing of four individual hanks of fiber 210 into PE tube 410 with four strings can facilitate to keep hanks 210 separate for ease of looping over back edge 140 of cruciform 100 at each end of sucker rod assembly 400.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. A carbon fiber rod assembly, the assembly comprising:
a) a retention insert;
b) a plurality of carbon fiber filaments wound around the retention insert and drawn into a length away from the retention insert;
c) a terminus fitting comprising a proximal end and a distal end defining a cavity therebetween, the terminus fitting flaring outwardly from the proximal end to the distal end, wherein the plurality of carbon fiber filaments are drawn through the cavity in the terminus fitting from the distal end to the proximal end until the retention insert is disposed in the cavity; and
d) resin disposed into the cavity, wherein the resin is infused in the plurality of carbon fiber filaments and constrains the plurality of carbon fiber filaments to the retention insert and to the terminus fitting when the resin hardens.

2. The assembly as set forth in claim 1, wherein the retention insert comprises a cruciform insert, further comprising a plurality of branches extending away form a cruciform joint, the plurality of branches spaced substantially equally apart, the plurality of carbon fiber filaments wound around at least one of the plurality of branches.

3. The assembly as set forth in claim 2, wherein each of the plurality of branches comprises a trapezoidal configuration.

4. The assembly as set forth in claim 1, wherein the retention insert comprises a rod insert.

5. The assembly as set forth in claim 1, wherein the plurality of carbon fiber filaments is under tension.

6. The assembly as set forth in claim 1, further comprising the resin infused in the plurality of carbon fiber filaments along the length away from the terminus fitting.

7. The assembly as set forth in claim 1, further comprising a plastic tube disposed around the plurality of carbon fiber filaments.

8. The assembly as set forth in claim 7, further comprising the resin infused in the plurality of carbon fiber filaments within the plastic tube.

9. The assembly as set forth in claim 7, further comprising a fiber sleeve enclosing the plurality of carbon fiber filaments within the plastic tube.

10. The assembly as set forth in claim 7, wherein the ratio of the plurality of carbon fiber filaments to resin by volume is in the range of approximately 60/40 to 75/25.

11. A carbon fiber rod assembly, the assembly comprising:
a) a plurality of loops of carbon fiber filaments stretched between a first end and a second end;
b) a retention insert disposed at each of the first and second ends;
c) a terminus fitting comprising a proximal end and a distal end defining a cavity therebetween, the terminus fitting flaring outwardly from the proximal end to the distal end, wherein the plurality of carbon fiber filaments are drawn through the cavity in the terminus fitting from the distal end to the proximal end until the retention insert is disposed in the cavity; and
d) resin disposed into the cavity, wherein the resin is infused in the plurality of loops of carbon fiber filaments and constrains the plurality of loops of carbon fiber filaments to the retention insert and to the terminus fitting when the resin hardens.

12. The assembly as set forth in claim 11, wherein the retention member comprises a cruciform insert, further comprising a plurality of branches extending away from a cruciform joint, the plurality of branches spaced substantially equally apart, wherein one or more of the plurality of loops of carbon fiber filaments are wrapped around each of the plurality of branches

13. The assembly as set forth in claim 12, wherein each of the plurality of branches comprises a trapezoidal configuration.

14. The assembly as set forth in claim 11, wherein the plurality of loops of carbon fiber filaments is under tension.

15. The assembly as set forth in claim 11, further comprising the resin infused in the plurality of carbon fiber filaments along the length away from the terminus fitting.

16. The assembly as set forth in claim 11, further comprising a plastic tube disposed around the plurality of loops of carbon fiber filaments.

17. The assembly as set forth in claim 16, further comprising the resin infused in the plurality of loops of carbon fiber filaments within the plastic tube.

18. The assembly as set forth in claim 16, further comprising a fiber sleeve enclosing the plurality of loops of carbon fiber filaments within the plastic tube.

19. The assembly as set forth in claim 16, wherein the ratio of the plurality of loops of carbon fiber filaments to resin by volume is in the range of approximately 60/40 to 75/25.

20. A method for assembling a carbon rod assembly, the method comprising the steps of:
a) stretching a plurality of loops of carbon fiber filaments between a first end and a second end;
b) placing a terminus fitting comprising a proximal end and a distal end defining a cavity therebetween, wherein the terminus fitting flares outwardly from the proximal end to the distal end, wherein the plurality of loops of carbon fiber filaments are drawn through the cavity in the terminus fitting;
c) placing a retention insert at each of the first and second ends;
d) wrapping the plurality of loops of carbon fiber filaments around the retention insert;
e) drawing the plurality of loops of carbon fiber filaments through the cavity in the terminus fitting from the distal end to the proximal end until the cruciform insert is disposed in the cavity; and
f) placing resin in the cavity, wherein the resin infuses in the plurality of loops of carbon fiber filaments and constrains the plurality of loops of carbon fiber filaments to the retention insert and to the terminus fitting when the resin hardens.

21. The method as set forth in claim 20, wherein the retention insert comprises a cruciform insert, further comprising a plurality of branches extending away from a joint, the plurality of branches spaced substantially equally apart;

22. The method as set forth in claim 21, wherein each of the plurality of branches comprises a trapezoidal configuration.

23. The method as set forth in claim 20, further comprising the step of placing a tubular mold around the plurality of loops of carbon fiber filaments.

24. The method as set forth in claim 23, further comprising the step of infusing the resin in the plurality of loops of carbon fiber filaments within the tubular mold.

25. The method as set forth in claim 23, further comprising the step of incorporating a flow media material within or around the plurality of carbon fiber filaments before placing the tubular mold around the plurality of loops of carbon fiber filaments.

26. The method as set forth in claim 23, further comprising the step of placing a fiber sleeve around the plurality of carbon fiber filaments before placing the tubular mold around the plurality of loops of carbon fiber filaments.

27. The method as set forth in claim 23, wherein the tubular mold comprises a clamshell mold.

28. The method as set forth in claim 27, further comprising the step of heating the clamshell mold to more rapidly cure the resin.

29. The method as set forth in claim 23, wherein the tubular mold comprises a plastic tube.

30. The method as set forth in claim 29, further comprising the step of manipulating the plastic tube to form a non-circular cross-sectional shape as the resin hardens.

31. The method as set forth in claim 29, further comprising the step of removing the plastic tube from the carbon rod assembly after the resin has hardened.
